(19) United States
(12) Patent Application Publication
(10) Pub. No.: US 2002/0154503 A1
(43) Pub. Date: Oct. 24, 2002

(54) Positioning structure of a pipe-type lamp

(76) Inventor: Wun Fang Pan, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/837,257

(22) Filed: Apr. 19, 2001

(51) Int. Cl. F21S 2/00

(52) U.S. Cl. 362/227

(57) ABSTRACT

This invention relates to a positioning structure of a pipe-type lamp, which includes an inner tube with bulb receivers and engaging holes for connecting with the bulbs at intervals easily and securely. The bulb is positioned in the receiver while the conductive wires of the bulb are extended outward and folded to insert into the nearby holes, which can be engaged with a metal pin for electrical connection between the bulbs to complete a decorative pipe-type lamp.

### BACKGROUND OF INVENTION

A pipe-type lamp is widely used, which includes one or more light bulb strings to be assembled in a transparent pipe for decoration. The light bulb string includes many bulbs, each of which is connected with each other by welding to combine the conductive wire of the nearby bulb. It is very trouble to connect the bulb in series by welding. Moreover, the connection between the conductive wires may be broken or released. The bulb is not positioned in a regular interval and is not connected firmly.

Accordingly, the primary object of the invention is to provide a positioning structure of a pipe-type lamp, which provides an inner tube to connect with the bulb at a desired position in secure. Now the features and advantages of the invention will be described in detail with reference to the accompanying drawings.

### BRIEF DESCRIPTION OF THE INVENTION

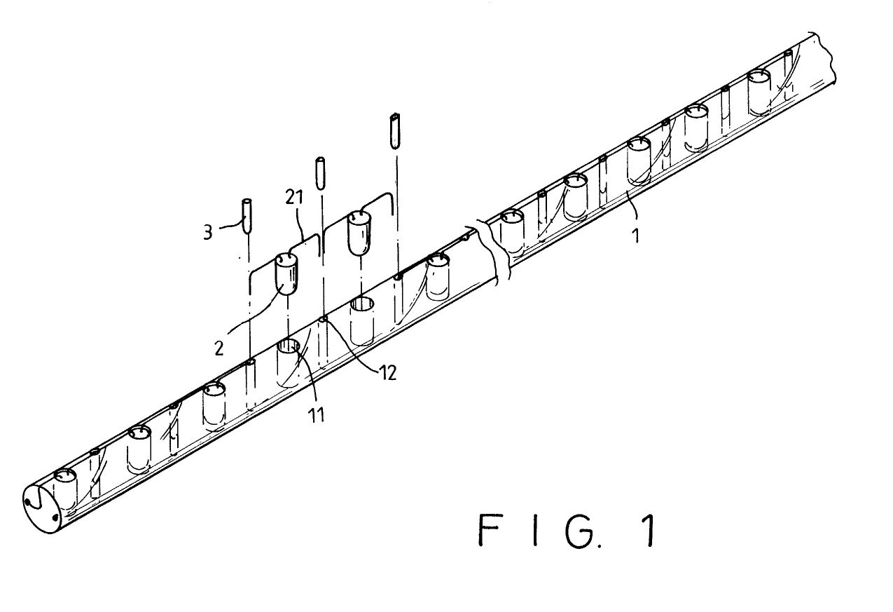

FIG. 1 is a schematic perspective view showing an inner tube and the bulb assembly of a pipe-type lamp according to the present invention.

FIG. 1 is a partly cross-sectional plan view of the pipe-type lamp according to the present invention.

### DETAILED DESCRIPTION OF THE INVENTION

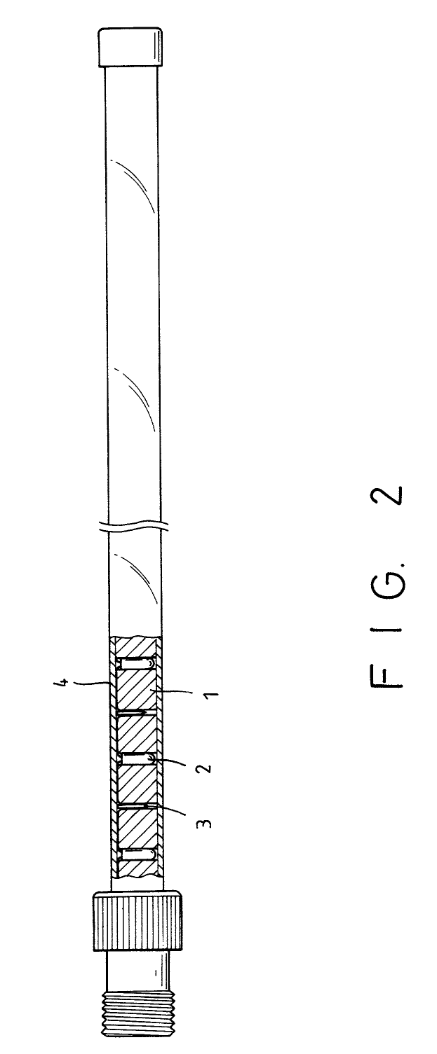

Please refer to FIGS. 1 and 2, the invention includes an inner tube (1), which is formed by extrusion molding with bulb receivers (11) and engaging holes (12) at intervals. The bulb (2) can be positioned in the receiver (11) easily and the two conductive wires (21) of the bulb (2) are extended outward and folded to insert into the two nearby engaging holes (12) respectively. A metal pin (3) can be engaged within the hole (12) to contact with two conductive wire (21) belong to two different bulb (2) at the same time securely that obtains the electrical connection of the nearby two bulbs (2). The metal pin (3) could be made of non-oxidized material.

After the bulbs (2) are connected within the inner tube (3), the tube (3) is covered by a transparent shell (4) to complete a pipe-type lamp. Accordingly, it is to be understood that the bulb can be easily positioned in the inner tube of the pipe-type lamp in secure and each bulb is positioned at a same interval that improves the decorative lighting effect and utility. Evidently it meets the requirements of granting a patent. We hereby file an application for a patent grant.

What is claimed is:

1. A positioning structure of a pipe-type lamp including an inner tube formed by extrusion molding with bulb receivers and engaging holes at intervals, and the bulb being positioned in the receiver and the two conductive wires of the bulb being extended outward and folded to insert into the two nearby engaging holes respectively; a metal pin being engaged within the hole to contact with two conductive wire belong to two different bulb at the same time securely that obtains the electrical connection of the nearby two bulbs; and the tube being covered by a transparent shell to complete a pipe-type lamp.

2. The positioning structure of a pipe-type lamp, wherein the metal pin is made of non-oxidized material.
